(19) United States
(12) Patent Application Publication
(10) Pub. No.: US 2025/0378119 A1
(43) Pub. Date: Dec. 11, 2025

(54) SYSTEMS AND METHODS FOR AUTOMATIC DATA AND INSIGHT SUPPORT USING NATURAL LANGUAGE MODEL

(71) Applicant: Walmart Apollo, LLC, Bentonville, AR (US)

(72) Inventors: Jayit Saha, Bengaluru (IN); Abhishek Sengupta, Bangalore (IN); Vijay Pandey, Bengaluru (IN); Ashwini Chandrashekharaiah, Bangalore (IN); Shirish Tatikonda, Milpitas, CA (US)

(21) Appl. No.: 19/227,819

(22) Filed: Jun. 4, 2025

Related U.S. Application Data
(60) Provisional application No. 63/656,245, filed on Jun. 5, 2024.

(51) Int. Cl. G06F 16/953; G06F 40/40

(52) U.S. Cl. CPC G06F 16/953; G06F 40/40

(57) ABSTRACT

Systems and methods for automatically providing data and insight supports using a natural language model are disclosed. In some embodiments, a disclosed method includes: receiving, from a computing device, a support request seeking an insight about a data platform; retrieving, based on the support request, an original description from at least one data source associated with the data platform; computing, using a natural language model, a degree of relevancy of the original description regarding the support request; generating, according to the degree of relevancy, a context description based on the original description; generating, using the natural language model, an enhanced description based on the context description; and transmitting the enhanced description to the computing device.

### CROSS REFERENCE TO RELATED APPLICATION

This application claims benefit to U.S. Patent Application No. 63/656,245, entitled “SYSTEMS AND METHODS FOR AUTOMATIC DATA AND INSIGHT SUPPORT USING NATURAL LANGUAGE MODEL,” filed on Jun. 5, 2024, the disclosure of which is incorporated herein by reference in its entirety.

### TECHNICAL FIELD

This application relates generally to data generation and conversion and, more particularly, to systems and methods for automatically providing data and insight supports using a natural language model.

### BACKGROUND

People, in about every position of any business, need to learn and understand data and insights every day, to take appropriate decisions and/or learn new ideas. While a big data platform can provide data to hundreds of thousands of users, original data collected for learning or decision-making has a huge size and is not organized in a way to provide insights to users. Accordingly, many support tickets related to data and/or process on the data platform are raised by these users every month. The mean time to resolve these tickets keeps increasing as more and more users join the platform, which requires a long learning curve and extensive trainings for a new user to understand how to use the data platform.

In addition, existing methods of handling support tickets are manually performed by a multi-tiered support team, which includes different tiers each handling a different part of the ticket support process. As the user size or the platform size increases, manually handling these tickets would be an extremely daunting if not impossible task. Further, some very critical insights might be missed due to manual efforts in resolving the tickets.

### SUMMARY

The embodiments described herein are directed to systems and methods for automatically providing data and insight supports using a natural language model.

In various embodiments, a system including a non-transitory memory configured to store instructions thereon and at least one processor is disclosed. The at least one processor is operatively coupled to the non-transitory memory and configured to read the instructions to: receive, from a computing device, a support request seeking an insight about a data platform; retrieve, based on the support request, an original description from at least one data source associated with the data platform; compute, using a natural language model, a degree of relevancy of the original description regarding the support request; generate, according to the degree of relevancy, a context description based on the original description; generate, using the natural language model, an enhanced description based on the context description; and transmit the enhanced description to the computing device. In some embodiments, before computing the degree of relevancy, the at least one processor is configured to classify, using machine learning algorithms and/or heuristics, context of the support request, access permissions of the user raising the support request, etc.

In various embodiments, a computer-implemented method is disclosed. The computer-implemented method includes: receiving, from a computing device, a support request seeking an insight about a data platform; retrieving, based on the support request, an original description from at least one data source associated with the data platform; computing, using a natural language model, a degree of relevancy of the original description regarding the support request; generating, according to the degree of relevancy, a context description based on the original description; generating, using the natural language model, an enhanced description based on the context description; and transmitting the enhanced description to the computing device. In some embodiments, before computing the degree of relevancy, the method includes classifying, using machine learning algorithms and/or heuristics, context of the support request, access permissions of the user raising the support request, etc.

In various embodiments, a non-transitory computer readable medium having instructions stored thereon is disclosed. The instructions, when executed by at least one processor, cause at least one device to perform operations including: receiving, from a computing device, a support request seeking an insight about a data platform; retrieving, based on the support request, an original description from at least one data source associated with the data platform; computing, using a natural language model, a degree of relevancy of the original description regarding the support request; generating, according to the degree of relevancy, a context description based on the original description; generating, using the natural language model, an enhanced description based on the context description; and transmitting the enhanced description to the computing device. In some embodiments, before computing the degree of relevancy, the operations include classifying, using machine learning algorithms and/or heuristics, context of the support request, access permissions of the user raising the support request, etc.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 is a network environment configured for automatically providing data and insight supports, in accordance with some embodiments of the present teaching;

FIG. 2 is a block diagram of a support computing device, in accordance with some embodiments of the present teaching;

FIG. 3 is a block diagram illustrating various portions of a system for automatically providing data and insight supports, in accordance with some embodiments of the present teaching;

FIG. 4 illustrates an exemplary system architecture for automatically providing data and insight supports for a data platform, in accordance with some embodiments of the present teaching;

FIG. 5 illustrates exemplary processes for ticket classification and routing, in accordance with some embodiments of the present teaching;

FIGS. 6A-6C illustrate an exemplary process for generating an enhanced description as a support response, in accordance with some embodiments of the present teaching;

FIG. 7 illustrates an exemplary process for generating a description for a data element with missing or incomplete definition, in accordance with some embodiments of the present teaching;

FIG. 8 illustrates an exemplary user interface for presenting a support response including an enhanced description, in accordance with some embodiments of the present teaching;

FIG. 9 illustrates an exemplary user interface for presenting a support response including an original description, in accordance with some embodiments of the present teaching;

FIG. 10 illustrates an exemplary process for generating and presenting a support response via a chatbot, in accordance with some embodiments of the present teaching;

FIG. 11 shows a flowchart illustrating an exemplary method for automatically providing data and insight supports using a natural language model, in accordance with some embodiments of the present teaching.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

It is crucial for a data platform to provide a good support to users who request data and insights (e.g. by inputting queries or creating tickets) on the data platform for them to make appropriate decisions. For example, a big retailer may provide a data product to give merchants and suppliers access to rich and aggregated customer insights that can enable their smarter and faster decision-making.

One objective of various embodiments in the present teaching is to develop systems and methods for automatically providing data and insight supports using a natural language model. In some embodiments, a disclosed system provides an automatic support tool harnessing machine learning and artificial intelligence (AI) to develop self-learn-and-fix functionalities. The automatic support tool can effectively reduce the number of tickets created, improve ticket resolution metrics like mean time to resolution (MTTR) and first time response rates (FTTR), and easily simplify and scale the support process.

In some examples, the natural language model is a large language model. In some embodiments, one or more filtering and/or review processes may be implemented at various stages to identify and/or prevent generation of undesirable content by the large language model or any other model. For example, one or more filtering processes may be applied to identify, remove, and/or otherwise eliminate undesirable content such as inappropriate content, offensive images, restricted images, etc. Although specific embodiments are discussed herein, it will be appreciated that any suitable filtering may be applied at any suitable steps of the disclosed methods.

In some embodiments, a disclosed system both provides the user with a machine learning based tool with self-repair functionalities, and provides ammunition to the support team of the platform to reach the solution quickly and more efficiently. In some embodiments, the disclosed system includes but not limited to the following modules: a module for tickets classification and routing, a data assistant tool, and a chatbot.

In some examples, the module for tickets classification and routing includes a machine learning based classifier to classify the tickets in real-time, e.g. into bugs, defects and enhancements, and routes the tickets to appropriate queues for quicker triaging. This can lead to quicker resolutions, resulting in an improvement of FTTR metrics. In addition, the system can extract relevant themes to surface “hot topics” to the support team to facilitate prioritization of different tickets based on the tickets classification.

In some examples, the data assistant tool uses a natural language model (e.g. a large language model) to provide a dictionary type view of all data elements (columns, tables, glossaries) of the data platform, and provides enhanced descriptions for any data elements with incomplete or missing definitions. The data assistant provides users as well the support team with a self-serve single point of truth for all data element queries with added description enhancement capabilities, even when the data elements are fragmented across multiple data sources with a substantial portion of data elements being incomplete, missing or poorly annotated. The data assistant also provides a single searchable platform across all these sources akin to a dictionary type view, and auto-generates enhanced descriptions for missing definitions and/or incomplete definitions, e.g. using an adaptive retrieval augmented generation (ARAG) architecture.

In some examples, the chatbot is a self-serve chatbot having capability to help both users and the support team of the data platform. The chatbot can leverage large language models finetuned on historical tickets and knowledge databases of the data platform, e.g. with a feedback mechanism based on inverse reinforcement learning for continuous improvement of answers to queries or tickets via the chatbot conversations. For example, the feedback mechanism may collect feedbacks from users who vote on whether the automatically generated answer or resolution is correct or not.

In some embodiments, a disclosed system provides a holistic support suite that handles: various ticket types like data and process related queries, multiple user personas with access controls and regulated responses, and an automated support for both external users and internal support teams. The disclosed system can automatically provide data and insight supports to: reduce user tickets, lower MTTR, bring down the support team hours or totally remove the regular human efforts from the support team on ticket resolution, resulting in significant cost savings and user experience enhancement.

Furthermore, in the following, various embodiments are described with respect to systems and methods for automatically providing data and insight supports using a natural language model are disclosed. In some embodiments, a disclosed method includes: receiving, from a computing device, a support request seeking an insight about a data platform; retrieving, based on the support request, an original description from at least one data source associated with the data platform; computing, using a natural language model, a degree of relevancy of the original description regarding the support request; generating, according to the degree of relevancy, a context description based on the original description; generating, using the natural language model, an enhanced description based on the context description; and transmitting the enhanced description to the computing device.

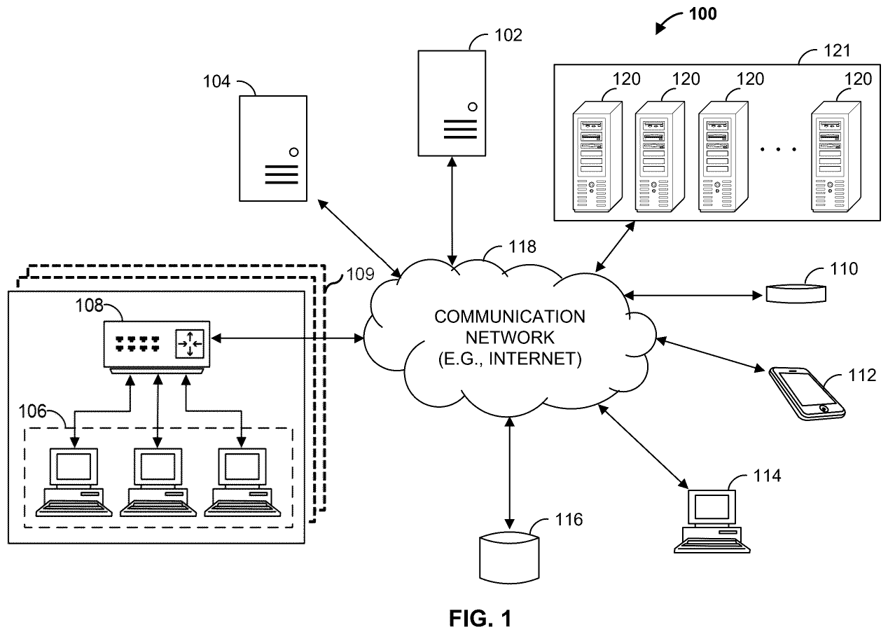

Turning to the drawings, FIG. 1 is a network environment 100 configured for automatically providing data and insight supports, in accordance with some embodiments of the present teaching. The network environment 100 includes a plurality of devices or systems configured to communicate over one or more network channels, illustrated as a network cloud 118. For example, in various embodiments, the network environment 100 can include, but not limited to, a support computing device 102, a server 104 (e.g., a web server or an application server), a cloud-based engine 121 including one or more processing devices 120, workstation(s) 106, a database 116, and one or more user computing devices 110, 112, 114 operatively coupled over the network 118. The support computing device 102, the server 104, the workstation(s) 106, the processing device(s) 120, and the multiple user computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over the communication network 118.

In some examples, each of the support computing device 102 and the processing device(s) 120 can be a computer, a workstation, a laptop, a server such as a cloud-based server, or any other suitable device. In some examples, each of the processing devices 120 is a server that includes one or more processing units, such as one or more graphical processing units (GPUs), one or more central processing units (CPUs), and/or one or more processing cores. Each processing device 120 may, in some examples, execute one or more virtual machines. In some examples, processing resources (e.g., capabilities) of the one or more processing devices 120 are offered as a cloud-based service (e.g., cloud computing). For example, the cloud-based engine 121 may offer computing and storage resources of the one or more processing devices 120 to the support computing device 102.

In some examples, each of the multiple user computing devices 110, 112, 114 can be a cellular phone, a smart phone, a tablet, a personal assistant device, a voice assistant device, a digital assistant, a laptop, a computer, a laser-based code scanner, or any other suitable device. In some examples, the server 104 hosts one or more websites or apps providing one or more products or services. In some examples, the support computing device 102, the processing devices 120, and/or the server 104 are operated by a retailer, and the multiple user computing devices 110, 112, 114 are operated by merchants, suppliers, associates, or managers of the retailer. In some examples, the processing devices 120 are operated by a third party (e.g., a cloud-computing provider).

The workstation(s) 106 are operably coupled to the communication network 118 via a router (or switch) 108. The workstation(s) 106 and/or the router 108 may be located at one or more stores 109 of a retailer, for example. The workstation(s) 106 can communicate with the support computing device 102 over the communication network 118. The workstation(s) 106 may send data to, and receive data from, the support computing device 102. For example, the workstation(s) 106 may transmit data identifying items purchased by a customer at the one or more stores 109 to the support computing device 102. The workstation(s) 106 may also transmit other data related to the one or more stores 109 to the support computing device 102.

Although FIG. 1 illustrates three user computing devices 110, 112, 114, the network environment 100 can include any number of user computing devices 110, 112, 114. Similarly, the network environment 100 can include any number of the support computing devices 102, the processing devices 120, the workstations 106, the stores 109, the servers 104, and the databases 116.

The communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 can provide access to, for example, the Internet.

In some embodiments, each of the first user computing device 110, the second user computing device 112, and the Nth user computing device 114 may communicate with the server 104 over the communication network 118. For example, each of the multiple user computing devices 110, 112, 114 may be operable to view, access, and interact with a website, such as a retailer's website, hosted by the server 104. Similarly, each of the multiple user computing devices 110, 112, 114 may be operable to view, access, and interact with an application programming interface (API) hosted by the server 104.

In some examples, the server 104 transmits a support request to the support computing device 102. The support request may be sent together with a selection of one or more filters provided by a user, or a standalone support request in response to the user's action on a website, e.g. clicking a button on the website, submitting a request on the website, or creating a ticket on the website.

In one example, a merchant or supplier is interested in online shoppers' behavior and submits a request on a website hosted by the server 104 associated with a data platform, e.g. by clicking on a button indicating a ticket creation or inputting a query via a chatbot interface, seeking for descriptions of a data element or a data process on the data platform. The server 104 may then send a support request to the support computing device 102. In response to receiving the support request, the support computing device 102 may retrieve an original description from at least one data source associated with the data platform, and generate, using a natural language model, an enhanced description based on the original description. The support computing device 102 may transmit the enhanced description as a support response to the server 104 to be displayed to the merchant or supplier. In other examples, users of the data platform may include: a seller, an advertiser, a customer, or an associate of the retailer.

In some embodiments, the support computing device 102 is further operable to communicate with the database 116 over the communication network 118. For example, the support computing device 102 can store data to, and read data from, the database 116. The database 116 can be a remote storage device, such as a cloud-based server, a disk (e.g., a hard disk), a memory device on another application server, a networked computer, or any other suitable remote storage. Although shown remote to the support computing device 102, in some examples, the database 116 can be a local storage device, such as a hard drive, a non-volatile memory, or a USB stick. For example, the support computing device 102 may store online purchase data received from the server 104 in the database 116. The support computing device 102 may receive in-store purchase data and store related data from the one or more stores 109 and store them in the database 116.

In some examples, the support computing device 102 generates and/or updates different models (e.g., machine learning models, deep learning models, statistical models, algorithms, etc.) for automatically providing data and insight supports. The support computing device 102 may generate training data for the models based on data including but not limited to: historical tickets, historical ticket resolutions, data in knowledge databases, and feedback data from users or managers of the data platform. The support computing device 102 trains the models based on their corresponding training data, and stores the models in a database, such as in the database 116 (e.g., a cloud storage). The models, when executed by the support computing device 102, allow the support computing device 102 to generate support responses for users.

In some examples, the support computing device 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some examples, the virtual machines assign each model (or part thereof) among a plurality of processing units. Based on the output of the models, the support computing device 102 may generate support responses including data and/or insights, to be displayed via a website or a chatbot interface to users.

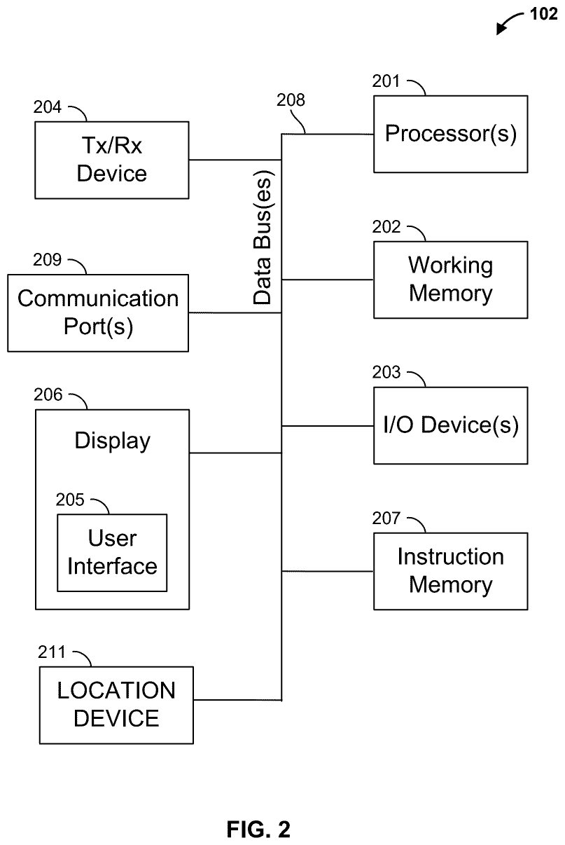

FIG. 2 illustrates a block diagram of a support computing device, e.g. the support computing device 102 of FIG. 1, in accordance with some embodiments of the present teaching. In some embodiments, each of the support computing device 102, the server 104, the workstation(s) 106, the multiple user computing devices 110, 112, 114, and the one or more processing devices 120 in FIG. 1 may include the features shown in FIG. 2. Although FIG. 2 is described with respect to certain components shown therein, it will be appreciated that the elements of the support computing device 102 can be combined, omitted, and/or replicated. In addition, it will be appreciated that additional elements other than those illustrated in FIG. 2 can be added to the support computing device 102.

As shown in FIG. 2, the support computing device 102 can include one or more processors 201, an instruction memory 207, a working memory 202, one or more input/output devices 203, one or more communication ports 209, a transceiver 204, a display 206 with a user interface 205, and an optional location device 211, all operatively coupled to one or more data buses 208. The data buses 208 allow for communication among the various components. The data buses 208 can include wired, or wireless, communication channels.

The one or more processors 201 can include any processing circuitry operable to control operations of the support computing device 102. In some embodiments, the one or more processors 201 include one or more distinct processors, each having one or more cores (e.g., processing circuits). Each of the distinct processors can have the same or different structure. The one or more processors 201 can include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 201 may also be implemented by a controller, a microcontroller, an application specific integrated circuit (ASIC), a field programmable gate array (FPGA), a programmable logic device (PLD), etc.

In some embodiments, the one or more processors 201 are configured to implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 207 can store instructions that can be accessed (e.g., read) and executed by at least one of the one or more processors 201. For example, the instruction memory 207 can be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 201 can be configured to perform a certain function or operation by executing code, stored on the instruction memory 207, embodying the function or operation. For example, the one or more processors 201 can be configured to execute code stored in the instruction memory 207 to perform one or more of any function, method, or operation disclosed herein.

Additionally, the one or more processors 201 can store data to, and read data from, the working memory 202. For example, the one or more processors 201 can store a working set of instructions to the working memory 202, such as instructions loaded from the instruction memory 207. The one or more processors 201 can also use the working memory 202 to store dynamic data created during one or more operations. The working memory 202 can include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 207 and working memory 202, it will be appreciated that the support computing device 102 can include a single memory unit configured to operate as both instruction memory and working memory. Further, although embodiments are discussed herein including non-volatile memory, it will be appreciated that the support computing device 102 can include volatile memory components in addition to at least one non-volatile memory component.

In some embodiments, the instruction memory 207 and/or the working memory 202 includes an instruction set, in the form of a file for executing various methods, e.g. any method as described herein. The instruction set can be stored in any acceptable form of machine-readable instructions, including source code or various appropriate programming languages. Some examples of programming languages that can be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter is configured to convert the instruction set into machine executable code for execution by the one or more processors 201.

The input-output devices 203 can include any suitable device that allows for data input or output. For example, the input-output devices 203 can include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 204 and/or the communication port(s) 209 allow for communication with a network, such as the communication network 118 of FIG. 1. For example, if the communication network 118 of FIG. 1 is a cellular network, the transceiver 204 is configured to allow communications with the cellular network. In some embodiments, the transceiver 204 is selected based on the type of the communication network 118 the support computing device 102 will be operating in. The one or more processors 201 are operable to receive data from, or send data to, a network, such as the communication network 118 of FIG. 1, via the transceiver 204.

The communication port(s) 209 may include any suitable hardware, software, and/or combination of hardware and software that is capable of coupling the support computing device 102 to one or more networks and/or additional devices. The communication port(s) 209 can be arranged to operate with any suitable technique for controlling information signals using a desired set of communications protocols, services, or operating procedures. The communication port(s) 209 can include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 209 allows for the programming of executable instructions in the instruction memory 207. In some embodiments, the communication port(s) 209 allow for the transfer (e.g., uploading or downloading) of data, such as machine learning model training data.

In some embodiments, the communication port(s) 209 are configured to couple the support computing device 102 to a network. The network can include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments can include in-body communications, various devices, and various modes of communications such as wireless communications, wired communications, and combinations of the same.

In some embodiments, the transceiver 204 and/or the communication port(s) 209 are configured to utilize one or more communication protocols. Examples of wired protocols can include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols can include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 206 can be any suitable display, and may display the user interface 205. For example, the user interfaces 205 can enable user interaction with the support computing device 102 and/or the server 104. For example, the user interface 205 can be a user interface for an application of a network environment operator that allows a customer to view and interact with the operator's website. In some embodiments, a user can interact with the user interface 205 by engaging the input-output devices 203. In some embodiments, the display 206 can be a touchscreen, where the user interface 205 is displayed on the touchscreen.

The display 206 can include a screen such as, for example, a Liquid Crystal Display (LCD) screen, a light-emitting diode (LED) screen, an organic LED (OLED) screen, a movable display, a projection, etc. In some embodiments, the display 206 can include a coder/decoder, also known as Codecs, to convert digital media data into analog signals. For example, the visual peripheral output device can include video Codecs, audio Codecs, or any other suitable type of Codec.

The optional location device 211 may be communicatively coupled to a location network and operable to receive position data from the location network. For example, in some embodiments, the location device 211 includes a GPS device configured to receive position data identifying a latitude and longitude from one or more satellites of a GPS constellation. As another example, in some embodiments, the location device 211 is a cellular device configured to receive location data from one or more localized cellular towers. Based on the position data, the support computing device 102 may determine a local geographical area (e.g., town, city, state, etc.) of its position.

In some embodiments, the support computing device 102 is configured to implement one or more modules or engines, each of which is constructed, programmed, configured, or otherwise adapted, to autonomously carry out a function or set of functions. A module/engine can include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine can also be implemented as a combination of the two, with certain functions facilitated by hardware alone, and other functions facilitated by a combination of hardware and software. In certain implementations, at least a portion, and in some cases, all, of a module/engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine can be realized in a variety of physically realizable configurations, and should generally not be limited to any particular implementation exemplified herein, unless such limitations are expressly called out. In addition, a module/engine can itself be composed of more than one sub-modules or sub-engines, each of which can be regarded as a module/engine in its own right. Moreover, in the embodiments described herein, each of the various modules/engines corresponds to a defined autonomous functionality; however, it should be understood that in other contemplated embodiments, each functionality can be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

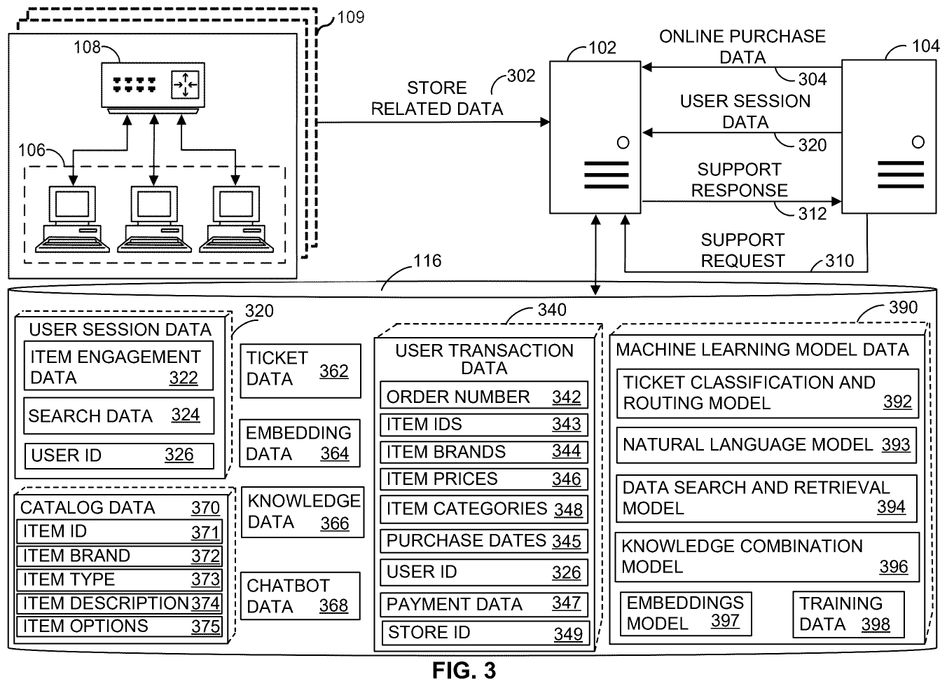

FIG. 3 is a block diagram illustrating various portions of a system for automatically providing data and insight supports, e.g. the system shown in the network environment 100 of FIG. 1, in accordance with some embodiments of the present teaching. As indicated in FIG. 3, the support computing device 102 may receive user session data 320 from the server 104, and store the user session data 320 in the database 116. The user session data 320 may identify, for each user (e.g., supplier, merchant, customer or manager), data related to that user's browsing session, such as when browsing a retailer's webpage or API hosted by the server 104.

In some examples, the user session data 320 may include item engagement data 322, search data 324, and user ID 326 (e.g., a customer ID, supplier ID, manager ID, retailer website login ID, a cookie ID, etc.). The item engagement data 322 may include one or more of a session ID (i.e., a website browsing session identifier), click data identifying data elements or items which a user clicked, data functions used by the user, advertisements viewed or clicked by the user during the browsing session, etc.

The support computing device 102 may also receive online purchase data 304 from the server 104, which identifies and characterizes one or more online purchases, such as purchases made by the user and other users via a retailer's website hosted by the server 104. The support computing device 102 may also receive store related data 302 from the one or more stores 109, which identifies and characterizes one or more in-store purchases. In some embodiments, the store related data 302 may also indicate other information about the one or more stores 109.

The support computing device 102 may parse the store related data 302 and the online purchase data 304 to generate user transaction data 340. In this example, the user transaction data 340 may include, for each purchase, one or more of: an order number 342 identifying a purchase order, item IDs 343 identifying one or more items purchased in the purchase order, item brands 344 identifying a brand for each item purchased, item prices 346 identifying the price of each item purchased, item categories 348 identifying a product type (or category) of each item purchased, purchase dates 345 identifying the purchase dates of the purchase orders, user ID 326 for the user making the corresponding purchase, payment data 347 indicating payment methods and related information (e.g. emails associated with payment) for corresponding online orders, and store ID 349 for the corresponding in-store purchase, or for the pickup store or shipping-from store associated with the corresponding online purchase.

In some embodiments, the database 116 may further store catalog data 370, which may identify one or more attributes of a plurality of items, such as a portion of or all items a retailer carries in stores and/or at e-commerce platforms. The catalog data 370 may identify, for each of the plurality of items, an item ID 371 (e.g., an SKU number), item brand 372, item type 373 (e.g., grocery item such as milk, clothing item), item description 374 (e.g., a description of the product including product features, such as item shelf, description, use or brand names, or any other suitable description), and item options 375 (e.g., item colors, sizes, flavors, etc.).

In some embodiments, the database 116 may further store ticket data 362, embedding data 364, knowledge data 366 and chatbot data 368. The ticket data 362 may identify tickets created, capture a conversation between the support ticket creator and a support team's representative, and their resolutions provided on a data platform or product. The embedding data 364 may identify embedding vectors generated for different topics of tickets. The knowledge data 366 may identify knowledge collected or generated from one or more knowledge databases, which are either sub-databases in the database 116 or standalone databases. The chatbot data 368 may identify data about conversations performed between online users and one or more chatbots associated with the server 104.

The database 116 may also store machine learning model data 390 identifying and characterizing one or more models and related data for automatically providing data and insight supports. For example, the machine learning model data 390 may include: a ticket classification and routing model 392, a natural language model 393, a data search and retrieval model 394, a knowledge combination model 396, an embeddings model 397, and training data 398.

The ticket classification and routing model 392 in this example can be used to classify tickets into different categories, e.g. bugs, defects and enhancements. The ticket classification and routing model 392 may include a machine learning model, e.g. a Bidirectional Encoder Representations from Transformers (BERT) model, to classify the tickets. The BERT model may be developed or fine-tuned based on historical ticketing data, e.g. historical tickets during last one year that are classified manually by a support team into different groups. In some examples, the ticket classification and routing model 392 may also include a machine learning model, e.g. a Latent Dirichlet Allocation (LDA) model, to identify the latent topics within each ticket, and then rank the topics to surface the most critical topics or “hot topics” for the ticket. In some examples, the ticket classification and routing model 392 in this example can also be used to route each classified ticket to a proper queue, to be processed by a corresponding support team or a corresponding support model.

The natural language model 393 can be used to generate and combine knowledge data. In some embodiments, the natural language model 393 is a large language model (LLM) used to compute a degree of relevancy of an original description regarding a support request. According to the degree of relevancy, a context description is generated based on the original description. The natural language model 393 can be further used to generate the enhanced description based on the context description, and provide responses to questions or queries.

The data search and retrieval model 394 in this example can be used to search and retrieve data from various data sources for a given ticket or request. For example, for a support request regarding a data element, the data search and retrieval model 394 may be used to search for definitions or descriptions about the data element in one or more knowledge databases, retrieve an original description for the data element from the one or more knowledge databases, and send to the natural language model 393 for evaluation of a relevancy of the retrieved original description to the support request. In some examples, the data search and retrieval model 394 may also be used to search for definitions or descriptions about the data element in external knowledge databases or the Internet.

The knowledge combination model 396 in this example can be used to generate and combine knowledge data for a given ticket or request. For example, for a support request regarding a data element, the knowledge combination model 396 may be used to generate internal knowledge data based on a refinement of the original description retrieved by the data search and retrieval model 394, and generate external knowledge data based a search performed by the data search and retrieval model 394 in the external knowledge databases or the Internet. In some examples, the knowledge combination model 396 may be used to combine the internal knowledge data and the external knowledge data to generate a final context, which is input to the natural language model 393 to generate an enhanced description for the ticket or request.

The embeddings model 397 in this example can be used to generate embedding vectors for a ticket, a request, data elements and process elements in databases of a data platform. For example, the embeddings model 397 can be used to generate embedding vectors for all data elements and process elements in knowledge databases of the data platform, such that the embedding vectors are in a same high-dimensional embedding space. For given ticket or request, the embeddings model 397 may be used to generate a corresponding embedding vector in the same embedding space, such that the data search and retrieval model 394 can use the corresponding embedding vector to search for a match or closest embedding vector in the embedding space to find matching data elements and/or process elements.

The training data 398 may include data utilized for training one or more of the ticket classification and routing model 392, the natural language model 393, the data search and retrieval model 394, the knowledge combination model 396 and the embeddings model 397. In some examples, the training data 398 may be formed based on: historical tickets, historical ticket resolutions, data in knowledge databases, synthetic ticketing data generated based on historical ticketing data, and feedback data from users or managers of the data platform. In some examples, the training data 398 is updated based on updated ticketing data and/or updated feedback data. In some embodiments, the machine learning model data 390 includes any number of the ticket classification and routing model(s) 392, the natural language model(s) 393, the data search and retrieval model(s) 394, the knowledge combination model(s) 396, and the embeddings model(s) 397.

In some examples, the support computing device 102 receives a support request 310 from the server 104. The support request 310 may seek an insight about a data platform. In some embodiments, the support computing device 102 may retrieve, based on the support request, an original description from at least one data source associated with the data platform, and compute a degree of relevancy of the original description regarding the support request using a natural language model, e.g. the natural language model 393. Then, the support computing device 102 can generate, according to the degree of relevancy, a context description based on the original description, and generate an enhanced description based on the context description using a natural language model, e.g. the natural language model 393. In response to the support request 310, the support computing device 102 transmits the enhanced description as a support response 312 to the server 104.

In some embodiments, the support computing device 102 may assign one or more of the above described operations to a different processing unit or virtual machine hosted by one or more processing devices 120. Further, the support computing device 102 may obtain the outputs of the these assigned operations from the processing units, and generate the support response 312 based on the outputs.

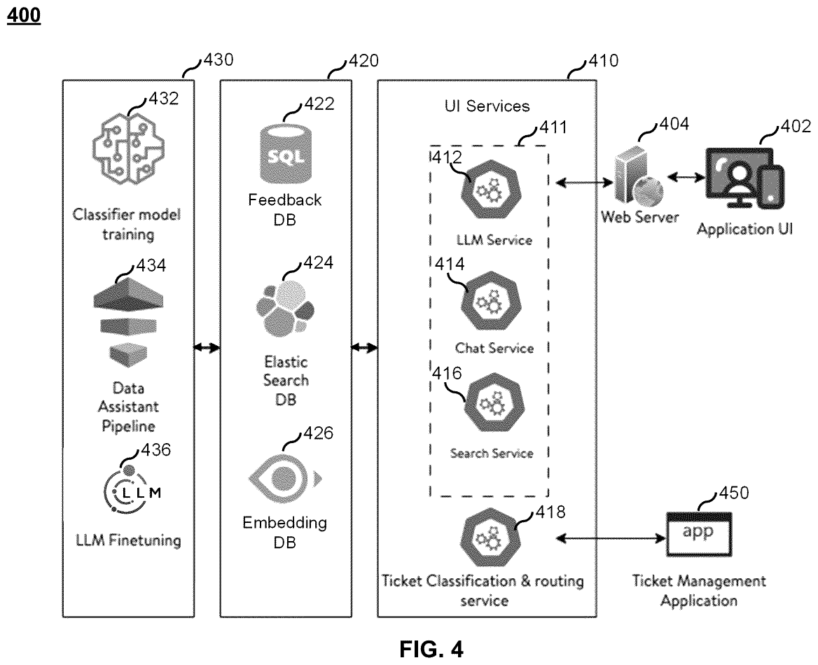

FIG. 4 illustrates an exemplary system architecture 400 for automatically providing data and insight supports for a data platform, in accordance with some embodiments of the present teaching. In some embodiments, the architecture 400 indicates a process that can be carried out by one or more computing devices, such as the support computing device 102, the server 104, and/or the cloud-based engine 121 of FIG. 1. As shown in FIG. 4, the architecture 400 includes an application user interface (UI) 402, a web server 404, a microservices layer 410, a data layer 420, a batch process layer 430, and a ticket management application 450. In some embodiments, the web server 404 is implemented as the server 104 of FIG. 1; the microservices layer 410, the data layer 420, the batch process layer 430, and the ticket management application 450 may be implemented as the support computing device 102 and/or the cloud-based engine 121 of FIG. 1.

As shown in FIG. 4, the microservices layer 410 in this example includes an LLM service unit 412, a chat service unit 414, a search service unit 416, and a ticket classification and routing service unit 418, to serve and answer requests in real-time. The LLM service unit 412, the chat service unit 414, and the search service unit 416 form UI services 411 to serve the incoming requests from the application UI 402 via the web server 404. The data layer 420 in this example includes a feedback database 422, an elastic search database 424, and an embedding database 426. Each of the feedback database 422, the elastic search database 424, and the embedding database 426 may be in the database 116 or a standalone database. The batch process layer 430 in this example includes a classifier model training unit 432, a data assistant pipeline unit 434, and an LLM finetuning unit 436.

In some embodiments, the application UI 402 is configured to receive user inputs about a request. In some examples, the application UI 402 is a UI on a website hosted by the web server 404 to receive a ticket created or submitted by a user, or receive a search query input by a user. In some examples, the application UI 402 is a UI or chat board of a chatbot hosted by the web server 404 to receive a question or query input by a user. The ticket, the question, or the query may indicate a request for insights or descriptions about a data element or data process on a data platform or data product provided by the web server 404.

The web server 404 in this example is configured to generate a support request based on the ticket, the question, or the query input by the user. The web server 404 can send the support request to the microservices layer 410, which is configured to serves all incoming requests from the application UI 402 via the web server 404.

The LLM service unit 412 in this example is configured to apply an LLM model, e.g. the natural language model 393, to the support request to generate a description for the data element or data process based on various internal databases of the data platform. The LLM service unit 412 may also be configured to generate an enhanced description based on a combination of knowledge data retrieved or generated from the various internal databases, external databases, and/or the Internet.

The chat service unit 414 in this example is configured to store conversational data and contextual data for a current user session of the user on a website or chatbot UI. The chat service unit 414 can store these data in a database, which may be the database 116 or a standalone database. Then for a subsequent support request, the LLM service unit 412 can search for the conversational data and contextual data for the support request from the database associated with the chat service unit 414, and generate an enhanced description based on the contextual data for the support request in the same user session. In some embodiments, the enhanced description is provided with a link to a knowledge database where a detailed answer is given for the support request.

In some examples, for a given query about a particular data element, the search service unit 416 in this example is configured to directly search and fetch that particular data element, e.g. from the elastic search database 424. The microservices layer 410 can then provide the corresponding particular data element, along with that LLM enhanced description provided by the LLM service unit 412 to the user.

In some embodiments, a user launches a ticket via the application UI 402. Then, after receiving the ticket via the web server 404, the ticket classification and routing service unit 418 in this example is configured to tag the ticket including a particular question to be a bug group, a defect group, or an enhancement group, using a classifier model. The ticket classification and routing service unit 418 may also send the ticket to a corresponding support team or support model, e.g. by auto-populating the ticket in a UI of the ticket management application 450, which is accessible to the corresponding support team, or by auto-resolving the ticket based on the support model associated with the ticket management application 450. The ticket management application 450 is integrated with the microservices layer 410 for managing tickets and generating resolutions.

The feedback database 422 in this example captures and stores user feedback data, indicating a degree of satisfaction from users for each ticket or request resolution. All feedbacks from the users (via a chatbot or a website) may be recorded along with the historical conversations that happened each day. The feedbacks can be provided back to a machine learning model, e.g. one model in the machine learning model data 390, to re-train and enhance the model.

The elastic search database 424 in this example stores indices for data elements and process elements, to enable a quicker elastic searching of those elements. The embedding database 426 in this example is a vector database for maintaining machine-readable information. In some embodiments, the system converts all textual information to embedding vectors (or any machine readable format) for a machine to understand, e.g. to feed into machine learning models utilized by the microservices layer 410. In some embodiments, the feedback data, the indexing and the embedding vectors in the data layer 420 can be used by the classifier model training unit 432, the data assistant pipeline unit 434 and the LLM finetuning unit 436 in the batch process layer 430. The data layer 420 can also output the model(s) trained or fine-tuned by the batch process layer 430, for real-time use at the microservices layer 410.

The classifier model training unit 432 in this example is configured to train the classifier model (or classification model), to classify incoming tickets into bugs, defects or enhancements. The training process may happen once per day, per week or per month as a batch process, rather than in real-time. In some examples, all incoming tickets are used to train the classifier model every day, every week or every month. The feedback data in the feedback database 422 may be used to re-train the classifier model to ensure its effectiveness of classifying new tickets.

The data assistant pipeline unit 434 in this example is configured to generate or update a pipeline for a data assistant, to be implemented by the LLM service unit 412 and the chat service unit 414 in real-time. The pipeline may be generated and updated based on embedding data, ticketing data and feedback data from the data layer 420.

The LLM finetuning unit 436 in this example is configured to fine tune the LLM model in a batch process. As newer ticketing data and feedback data coming in, the LLM finetuning unit 436 can re-train the LLM model to improve generation of enhanced data descriptions.

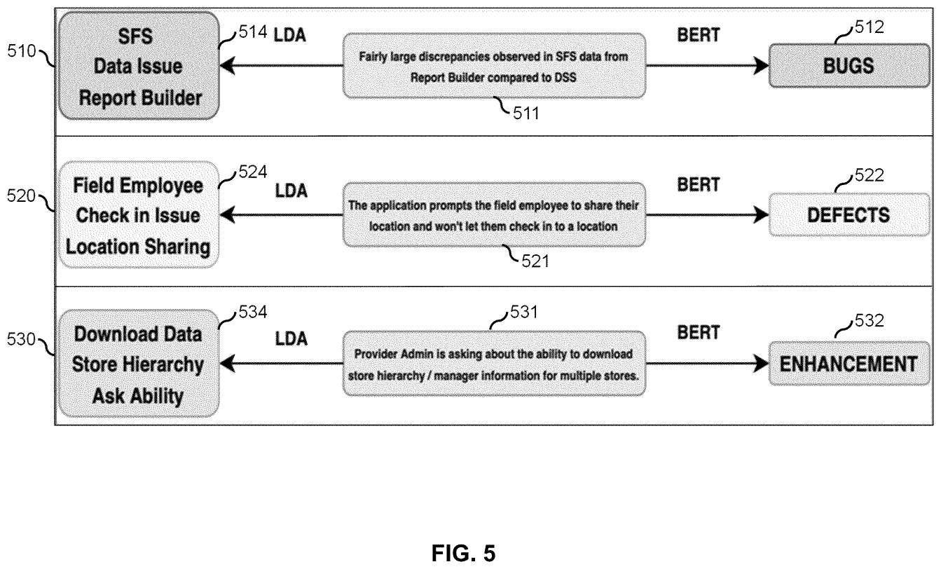

FIG. 5 illustrates exemplary processes for ticket classification and routing, in accordance with some embodiments of the present teaching. In some embodiments, the processes can be carried out by one or more computing devices, such as the support computing device 102, and/or the cloud-based engine 121 of FIG. 1.

As shown in FIG. 5, in the exemplary processes 510, 520, 530, a BERT model is applied to tickets to classify them into bugs, defects or enhancements; and an LDA model is used to identify latent topics within each ticket and then rank them to surface the most critical topics or “hot topics” for each ticket. In some embodiments, the BERT model is fine-tuned based on historical ticketing data.

In the exemplary process 510, a ticket 511 is obtained to recite “Fairly large discrepancies observed in SFS data from Report Builder compared to DSS.” By applying the BERT model to the ticket 511, the ticket 511 is classified into the bugs group 512. By applying the LDA model to the ticket 511, latent topics are identified within the ticket 511, to rank the topics and determine the hot topics 514 for the ticket 511. In this example, the hot topics 514 includes: SFS (shipped from store), data issue, report builder.

In the exemplary process 520, a ticket 521 is obtained to recite “The application prompts the field employee to share their location and won't let them check in to a location.” By applying the BERT model to the ticket 521, the ticket 521 is classified into the defects group 522. By applying the LDA model to the ticket 521, latent topics are identified within the ticket 521, to rank the topics and determine the hot topics 524 for the ticket 521. In this example, the hot topics 524 includes: field employee, check in issue, location sharing.

In the exemplary process 530, a ticket 531 is obtained to recite “Provider Admin is asking about the ability to download store hierarchy/manager information for multiple stores.” By applying the BERT model to the ticket 531, the ticket 531 is classified into the enhancement group 532. By applying the LDA model to the ticket 531, latent topics are identified within the ticket 531, to rank the topics and determine the hot topics 534 for the ticket 531. In this example, the hot topics 534 includes: download data, store hierarchy, ask ability.

In some embodiments, the exemplary processes 510, 520, 530 are performed by the ticket classification and routing service unit 418 in FIG. 4. Based on the classification and/or the hot topics, each of the tickets 511, 521, 531 will be routed to different teams or models for resolution generation. In some embodiments, based on the hot topics identified from different tickets received within each time period (e.g. each month), the system can determine the top themes (e.g. top three or five hottest topics) in each time period, to prioritize those tickets having the top themes in each time period (e.g. each month). That is, tickets and requests having a top trending theme in a particular time period are given priority to be resolved before other tickets and requests not having the top trending theme in the particular time period.

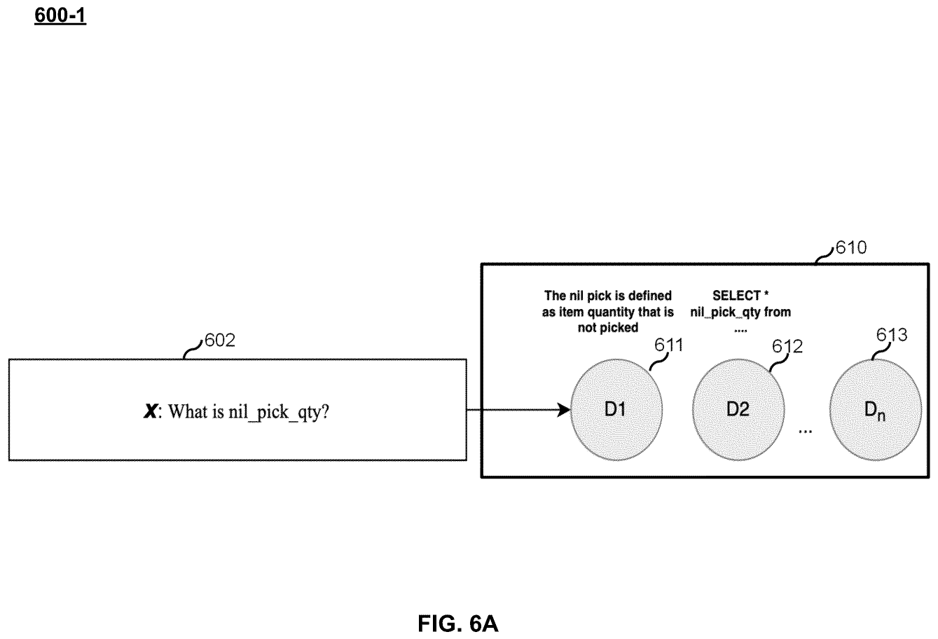

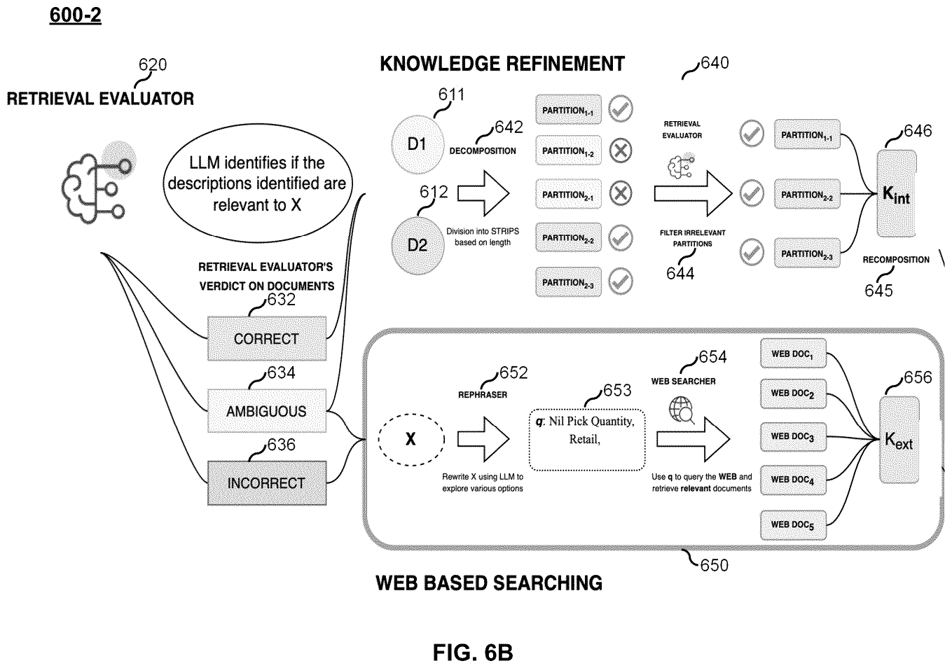

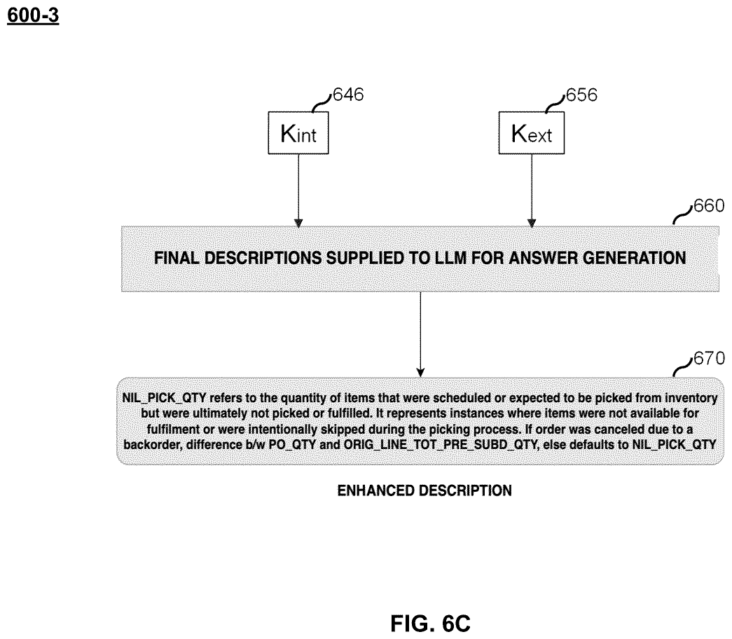

FIGS. 6A-6C illustrate an exemplary process 600 for generating an enhanced description as a support response, in accordance with some embodiments of the present teaching. In some embodiments, the process 600 can be carried out by one or more computing devices, such as the support computing device 102, and/or the cloud-based engine 121 of FIG. 1. In some embodiments, the process 600 corresponds to a data assistant pipeline generated by the data assistant pipeline unit 434 and performed by the LLM service unit 412 and the chat service unit 414 in FIG. 4. In some examples, the process 600 includes a sub-process 600-1 in FIG. 6A, a sub-process 600-2 in FIG. 6B, and a sub-process 600-3 in FIG. 6C.

As shown in FIG. 6A, the sub-process 600-1 starts from operation 602, where a support request 602 is received to seek insight about a data element of a data platform. In this example, the support request 602 includes a query X, reciting: “What is nil_pick_qty?” The query X may be input by a user via a conversation session with a chatbot, a ticket creation on a website or app UI, or through a query input window on a website or app UI. If the query X is input via a ticket, it may go through one of the processes 510, 520, 530 for ticket classification and routing, before proceeding to the process 600. If the query X is input via a query input window or chatbot UI, it may proceed directly to the process 600, without going through any of the processes 510, 520, 530.

Then at operation 610, the system determines one or more internal knowledge databases 611, 612, 613 based on the query X, and search each internal knowledge database to find matches for the query X to identify and retrieve descriptions. Each internal knowledge database is associated with the data platform, and may be part of the database 116 or a standalone database. In the example shown in FIG. 6A, a first description is retrieved from the internal knowledge database D1 611 to recite “The nil_pick is defined as item quantity that is not picked;” and a second description is retrieved from the internal knowledge database D2 612 to recite “SELECT*nil_pick_qty from . . . ” The process 600 then moves to the sub-process 600-2 in FIG. 6B.

In some embodiments, the sub-process 600-2 follows an adaptive retrieval augmented generation (RAG) architecture to produce a more complete data definition for the concerned data element “nil_pick_qty.” The adaptive RAG architecture combines RAG with classification and web-based enhancements, to ensure that the generated content aligns better with human expectations.

As shown in FIG. 6B, the sub-process 600-2 starts from operation 620, where the retrieved descriptions from the internal knowledge databases 611, 612, 613 are evaluated by a retrieval evaluator to determine if each retrieved description is relevant to the query X. For example, the retrieval evaluator may use an LLM to determine a degree of relevancy of each retrieved description to the query X. The degree of relevancy may include: correct 632, ambiguous 634 or incorrect 636. That is, the retrieval evaluator categorizes the retrieved descriptions into correct descriptions, ambiguous descriptions or incorrect descriptions. In this example, the description retrieved from the internal knowledge database D1 611 is an incomplete definition for nil_pick_qty, and is thus categorized as an ambiguous description; and the description retrieved from the internal knowledge database D2 612 is categorized as a correct description but still difficult for a user to understand.

In some examples, if a retrieved description (maybe called original description) is correct or ambiguous, the sub-process 600-2 goes to operation 640 for knowledge refinement, which includes operations of decomposition 642, partition filtering 644 and re-composition 645. During the decomposition 642, the system partitions each of the internal knowledge databases 611, 612 based on context lengths, context size, etc., to generate a plurality of partitions.

Then during the partition filtering 644, if there is any irrelevant components in a partition of the internal knowledge databases 611, 612, that irrelevant partition is filtered out or removed from consideration for enhanced description generation. The partition filtering 644 may be performed with a retrieval evaluator (e.g. using a trained LLM) to determine a degree of irrelevancy. In the example shown in FIG. 6B, the internal knowledge database 611 is divided to generate partitions 1-1 and 1-2, while the partition 1-2 is determined to be irrelevant and is therefore removed. In the example shown in FIG. 6B, the internal knowledge database 612 is divided to generate partitions 2-1, 2-2 and 2-3, while the partition 2-1 is determined to be irrelevant and is therefore removed. As such, only partitions 1-1, 2-2 and 2-3 are left to be correct or relevant after the partition filtering 644. Then during the re-composition 645, the correct partitions 1-1, 2-2 and 2-3 are combined to re-compose an internal knowledge data 646.

In some examples, if a retrieved description or original description is ambiguous or incorrect, the sub-process 600-2 goes to operation 650 for web based searching, which includes operations of a rephrase mechanism 652 and a web searcher 654. In some examples, the rephrase mechanism 652 is applied to rephrase the query X, e.g. to rewrite X using LLM to explore various options. In this example, the query X is rephrased to be query q 653, which recites: “Nil Pick Quantity, Retail.” The query q 653 is then used to search the web, e.g. the Internet, and retrieve relevant documents by the web searcher 654. In this example, the relevant documents (e.g. web doc 1 to web doc 5) are combined to generate external knowledge data 656.

The process 600 then moves to the sub-process 600-3 in FIG. 6C. As shown in FIG. 6C, the sub-process 600-3 starts from operation 660, where the internal knowledge data 646 and the external knowledge data 656 are combined to generate a final context, which is a culmination of all the data sources including web search. Then at operation 670, an enhanced description is generated by applying a natural language model (e.g. LLM) to the final context. In this example, the enhanced description in response to the query X includes a more complete definition for the concerned data element “nil_pick_qty,” compared to all the original descriptions.

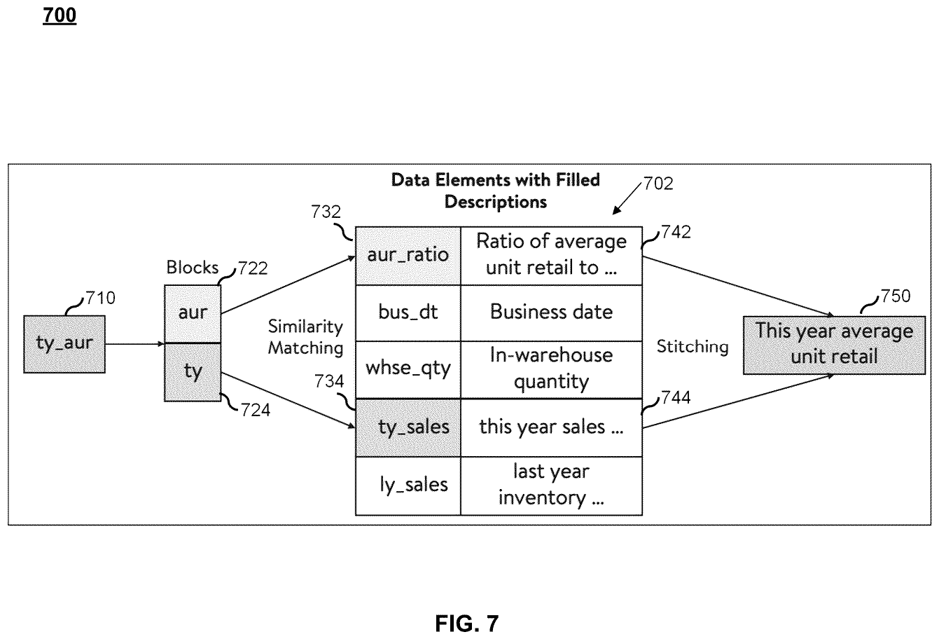

FIG. 7 illustrates an exemplary process 700 for generating a description for a data element 710 with missing or incomplete definition, in accordance with some embodiments of the present teaching. In some embodiments, the process 700 can be carried out by one or more computing devices, such as the support computing device 102, and/or the cloud-based engine 121 of FIG. 1.

As shown in FIG. 7, the process 700 starts from splitting each part of the data name of the data element 710 into its smallest blocks. In this example, the data element 710 is “ty_aur,” which is split into its smallest blocks “aur” 722 and “ty” 724. Then for each block of the smallest blocks “aur” 722 and “ty” 724, a similarity matching is performed between the block and the data elements with filled descriptions in an internal knowledge database, e.g. table 702. In this example, the matched data element to the block “aur” 722 is “aur_ratio” 732 with a description 742 reciting “Ratio of average unit retail to . . . ” In this example, the matched data element to the block “ty” 724 is “ty_sales” 734 with a description 744 reciting “this year sales” In some embodiments, the descriptions 742, 744 from these matched data elements 732, 734 are fed into the ARAG architecture in the sub-process 600-2 to get a stitched description 750 (“This year average unit retail”) for the data element 710. In some embodiments, the stitched description 750 may be used to generate the internal knowledge data 646 in the sub-process 600-2, when the original or retrieved description is a missing or incomplete definition for the concerned data element.

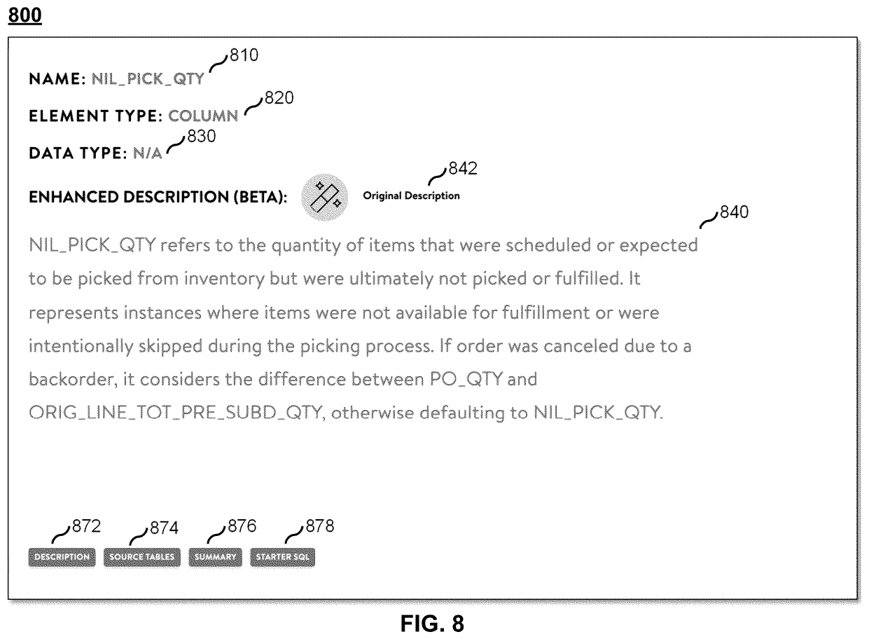

FIG. 8 illustrates an exemplary user interface 800 for presenting a support response including an enhanced description, in response to a support request, in accordance with some embodiments of the present teaching. In some embodiments, the user interface 800 can be presented by one or more computing devices, such as the server 104 of FIG. 1 or the web server 404 of FIG. 4.

As shown in FIG. 8, the user interface 800 includes: a name section 810 indicating the data name to be NIL_PICK_QTY for a data element queried by the support request, an element type section 820 indicating the element type for the data element to be COLUMN, a data type section 830 indicating the data type for the data element to be N/A, and an enhanced description section 840 including an enhanced description for the data element. In some embodiments, the enhanced description is generated based on the process 600 in FIGS. 6A-6C. In some embodiments, the user interface 800 further includes other elements related to the support response, like buttons 872, 874, 876, 878 for description, source tables, summary, and starter SQL, respectively.

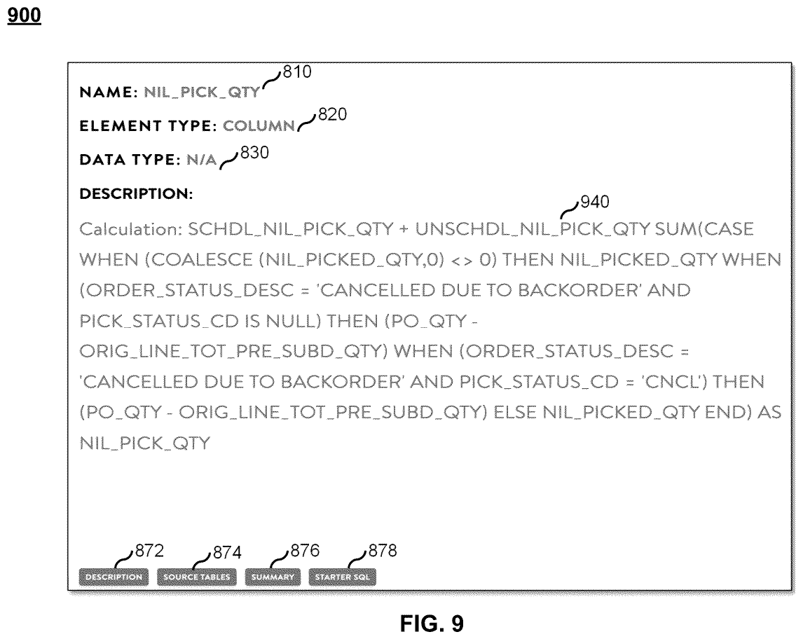

As shown in FIG. 8, the user interface 800 further includes an option 842 for the user to view an original description used to generate the enhanced description. In some embodiments, upon a user selection of the option 842, the user is directed to a user interface 900 for presenting a support response including an original description, as shown in FIG. 9, in accordance with some embodiments of the present teaching. As shown in FIG. 9 and FIG. 8, the user interface 900 is the same as the user interface 800, except that the user interface 900 includes an original description 940, rather than an enhanced description as in the user interface 800.

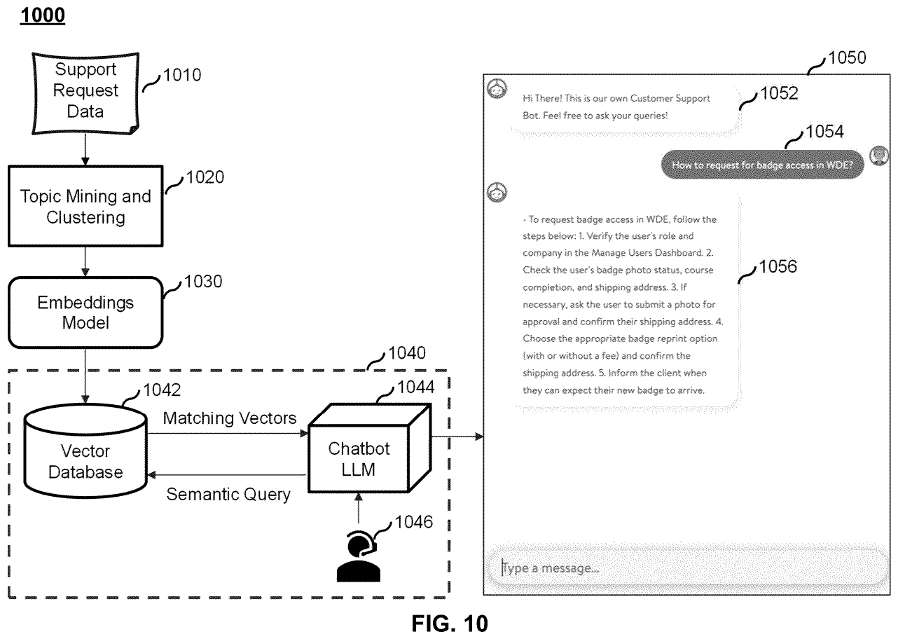

FIG. 10 illustrates an exemplary process 1000 for generating and presenting a support response via a chatbot, in accordance with some embodiments of the present teaching. In some embodiments, the process 1000 can be carried out by one or more computing devices, such as the support computing device 102, and/or the cloud-based engine 121 of FIG. 1.

As shown in FIG. 10, the process 1000 starts from operation 1010, where support request data is obtained. In some examples, the support request data includes but not limited to data related to: support tickets, support knowledge databases, internal knowledge databases, external knowledge databases, cloud databases.

At operation 1020, topic mining and clustering is performed to group similar tickets or support requests together. At operation 1030, an embeddings model is used to generate embedding vectors for the support tickets and requests, as well as for the data elements in the knowledge databases and cloud databases. The generated embedding vectors are stored in a vector database 1042, which may be part of the database 116 or a standalone database.

At operation 1040, a chatbot based LLM 1044 is used to perform as a chatbot to conduct a conversation 1050 in chatbot UI with a user. The chatbot based LLM can generate and send a semantic query to the vector database 1042 to retrieve matching vectors to the semantic query from the vector database 1042. A manager or associate 1046 may monitor and/or take over control of the conversation with the user if needed. In some embodiments, the operation 1040 can be performed based on an ARAG architecture of the process 600.

In the example shown in FIG. 10, during the conversation 1050, after an initial welcome message 1052 given by the chatbot, the user inputs a question 1054, reciting “How to request for badge access in WDE?” In response, the chatbot based LLM 1044 generates an enhanced description 1056 for the process of requesting for badge access in WDE, based on the operation 1040. For example, the chatbot based LLM can generate and send a semantic query based on the question 1054 to the vector database 1042 to retrieve matching vectors to the semantic query from the vector database 1042.

In some embodiments, for a data related query, the chatbot UI in FIG. 10 provides the enhanced description 1056 as a support response, without providing additional elements related to the support response, like buttons 872, 874, 876, 878 for description, source tables, summary, and starter SQL, respectively as shown in the user interfaces 800, 900 for a data assistant. In some embodiments, the chatbot UI in FIG. 10 can also handle a process related query, which is not handled by the data assistant via the user interfaces 800, 900.

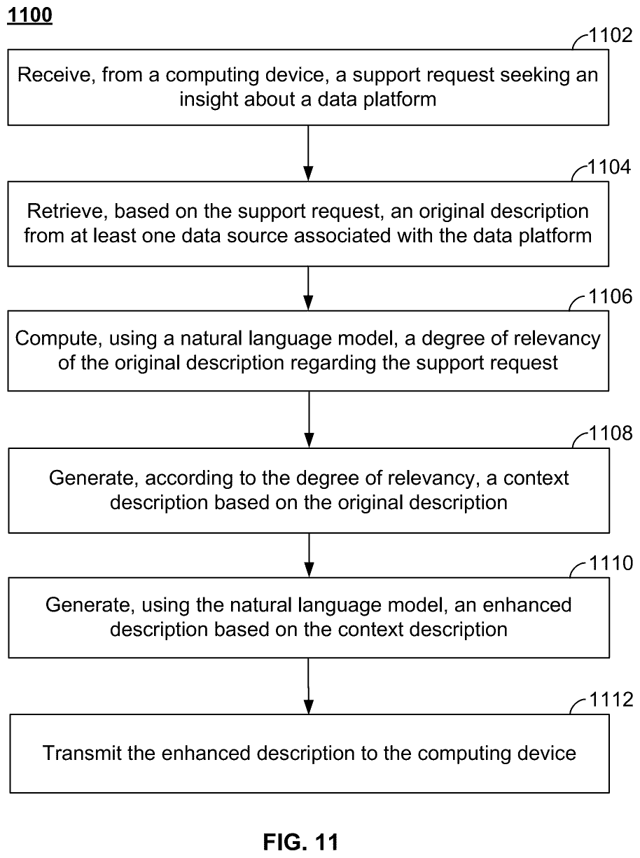

FIG. 11 is a flowchart illustrating an exemplary method 1100 for automatically providing data and insight supports using a natural language model, in accordance with some embodiments of the present teaching. In some embodiments, the method 1100 can be carried out by one or more computing devices, such as the support computing device 102 and/or the cloud-based engine 121 of FIG. 1. Beginning at operation 1102, a support request is received from a computing device, seeking an insight about a data platform. At operation 1104, an original description is retrieved based on the support request from at least one data source associated with the data platform. At operation 1106, based on a natural language model, a degree of relevancy of the original description is computed regarding the support request. According to the degree of relevancy, a context description is generated at operation 1108 based on the original description. At operation 1110, using the natural language model, an enhanced description is generated based on the context description. The enhanced description is transmitted at operation 1112 to the computing device.

Although the methods described above are with reference to the illustrated flowcharts, it will be appreciated that many other ways of performing the acts associated with the methods can be used. For example, the order of some operations may be changed, and some of the operations described may be optional.

In some embodiments, the disclosed system and method can be applied to a data product, like Walmart Luminate, to give merchants and suppliers access to rich and aggregated customer insights that can enable their smarter and faster decision-making. Walmart Luminate is a data and insights product that helps users (e.g. merchants and suppliers) to understand their shopper's behaviors and drivers, and their performance in stores and online. The disclosed system and method can automatically provide data and insight supports using a natural language model. The data and insight may be related to shopper behavior, customer perception, and/or channel performance, to help merchants and suppliers to easily understand the customers' needs and wants. Based on the disclosed system and method, a user can efficiently and effectively leverage a service like Walmart Luminate to obtain insights for category reviews, category planning, category assessment, assortment optimization, trade activity optimization, trade planning, multiple brand optimization, white space planning, marketing planning, category and channel strategy, portfolio optimization, etc.

The methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

Each functional component described herein can be implemented in computer hardware, in program code, and/or in one or more computing systems executing such program code as is known in the art. As discussed above with respect to FIG. 2, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 2.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of exemplary embodiments, it is not limited thereto. Rather, the appended claims should be construed broadly, to include other variants and embodiments, which can be made by those skilled in the art.

What is claimed is:

1. A system, comprising:
a processor; and
a non-transitory memory storing instructions that, when executed, cause the processor to:
receive, from a computing device, a support request seeking an insight about a data platform,
retrieve, based on the support request, an original description from at least one data source associated with the data platform,
compute, using a natural language model, a degree of relevancy of the original description regarding the support request,
generate, according to the degree of relevancy, a context description based on the original description,
generate, using the natural language model, an enhanced description based on the context description, and
transmit the enhanced description to the computing device.

2. The system of claim 1, wherein generating the context description comprises:
determining whether the original description is correct or incorrect or ambiguous based on the degree of relevancy;
in accordance with a determination that the original description is correct, performing a knowledge refinement on the original description to generate internal knowledge data;
in accordance with a determination that the original description is incorrect, performing a web based searching to generate external knowledge data;
in accordance with a determination that the original description is ambiguous, performing both the knowledge refinement and the web based searching to generate both the internal knowledge data and the external knowledge data;
generating the context description based on a combination of the internal knowledge data and the external knowledge data.

3. The system of claim 2, wherein performing the knowledge refinement comprises:
partitioning each of the at least one data source to generate a plurality of partitions;
determining, among the plurality of partitions, one or more partitions that are irrelevant based on a degree of irrelevancy generated by an additional natural language model;
removing the one or more partitions from the plurality of partitions to generate filtered partitions; and
combining the filtered partitions to generate the internal knowledge data.

4. The system of claim 2, wherein performing the web based searching comprises:
determining a query based on the support request;
rephrasing the query to generate a rephrased query using an additional natural language model;
searching online websites to retrieve relevant documents based on the rephrased query; and
combining the relevant documents to generate the external knowledge data.

5. The system of claim 1, wherein the instructions, when executed, further cause the processor to:
determine whether the support request is in form of a ticket, a question or a query; and
in accordance with a determination that the support request is in form of a ticket:
classify the ticket using a classifier model into a ticket group of a plurality of ticket groups including a bug group, a defect group and an enhancement group, and
auto-resolve the ticket based on a support model associated with the ticket group.

6. The system of claim 5, wherein the instructions, when executed, further cause the processor to:
obtain feedback data indicating a degree of satisfaction from users for resolutions of the support request and other support requests;
generate a training dataset based on the feedback data and historical conversations with the users; and
re-train the natural language model, the classifier model and the support model based on the training dataset.

7. The system of claim 5, wherein the instructions, when executed, further cause the processor to:
in accordance with a determination that the support request is in form of a question: present, via a user interface of a website, the enhanced description as an answer to the question, wherein the user interface comprises an option to display the original description; and
in accordance with a determination that the support request is in form of a query: present, via a user interface of a chatbot, the enhanced description as a response to the query.

8. A computer-implemented method, comprising:
receiving, from a computing device, a support request seeking an insight about a data platform;
retrieving, based on the support request, an original description from at least one data source associated with the data platform;
computing, using a natural language model, a degree of relevancy of the original description regarding the support request;
generating, according to the degree of relevancy, a context description based on the original description;
generating, using the natural language model, an enhanced description based on the context description; and
transmitting the enhanced description to the computing device.

9. The computer-implemented method of claim 8, wherein generating the context description comprises:
determining whether the original description is correct or incorrect or ambiguous based on the degree of relevancy;
in accordance with a determination that the original description is correct, performing a knowledge refinement on the original description to generate internal knowledge data;
in accordance with a determination that the original description is incorrect, performing a web based searching to generate external knowledge data;
in accordance with a determination that the original description is ambiguous, performing both the knowledge refinement and the web based searching to generate both the internal knowledge data and the external knowledge data;
generating the context description based on a combination of the internal knowledge data and the external knowledge data.

10. The computer-implemented method of claim 9, wherein performing the knowledge refinement comprises:
partitioning each of the at least one data source to generate a plurality of partitions;
determining, among the plurality of partitions, one or more partitions that are irrelevant based on a degree of irrelevancy generated by an additional natural language model;
removing the one or more partitions from the plurality of partitions to generate filtered partitions; and
combining the filtered partitions to generate the internal knowledge data.

11. The computer-implemented method of claim 9, wherein performing the web based searching comprises:
determining a query based on the support request;
rephrasing the query to generate a rephrased query using an additional natural language model;
searching online websites to retrieve relevant documents based on the rephrased query; and
combining the relevant documents to generate the external knowledge data.

12. The computer-implemented method of claim 8, further comprising:
determining whether the support request is in form of a ticket, a question or a query; and
in accordance with a determination that the support request is in form of a ticket:
classifying the ticket using a classifier model into a ticket group of a plurality of ticket groups including a bug group, a defect group and an enhancement group, and
auto-resolving the ticket based on a support model associated with the ticket group.

13. The computer-implemented method of claim 12, further comprising:
obtaining feedback data indicating a degree of satisfaction from users for resolutions of the support request and other support requests;
generating a training dataset based on the feedback data and historical conversations with the users; and
re-training the natural language model, the classifier model and the support model based on the training dataset.

14. The computer-implemented method of claim 12, further comprising:
in accordance with a determination that the support request is in form of a question: presenting, via a user interface of a website, the enhanced description as an answer to the question, wherein the user interface comprises an option to display the original description; and
in accordance with a determination that the support request is in form of a query: presenting, via a user interface of a chatbot, the enhanced description as a response to the query.

15. A non-transitory computer readable medium having instructions stored thereon, wherein the instructions, when executed by at least one processor, cause at least one device to perform operations comprising:
receiving, from a computing device, a support request seeking an insight about a data platform;
retrieving, based on the support request, an original description from at least one data source associated with the data platform;
computing, using a natural language model, a degree of relevancy of the original description regarding the support request;
generating, according to the degree of relevancy, a context description based on the original description;
generating, using the natural language model, an enhanced description based on the context description; and
transmitting the enhanced description to the computing device.

16. The non-transitory computer readable medium of claim 15, wherein generating the context description comprises:
determining whether the original description is correct or incorrect or ambiguous based on the degree of relevancy;
in accordance with a determination that the original description is correct, performing a knowledge refinement on the original description to generate internal knowledge data;
in accordance with a determination that the original description is incorrect, performing a web based searching to generate external knowledge data;
in accordance with a determination that the original description is ambiguous, performing both the knowledge refinement and the web based searching to generate both the internal knowledge data and the external knowledge data;
generating the context description based on a combination of the internal knowledge data and the external knowledge data.

17. The non-transitory computer readable medium of claim 16, wherein performing the knowledge refinement comprises:
partitioning each of the at least one data source to generate a plurality of partitions;
determining, among the plurality of partitions, one or more partitions that are irrelevant based on a degree of irrelevancy generated by an additional natural language model;
removing the one or more partitions from the plurality of partitions to generate filtered partitions; and
combining the filtered partitions to generate the internal knowledge data.

18. The non-transitory computer readable medium of claim 16, wherein performing the web based searching comprises:
determining a query based on the support request;
rephrasing the query to generate a rephrased query using an additional natural language model;
searching online websites to retrieve relevant documents based on the rephrased query; and
combining the relevant documents to generate the external knowledge data.

19. The non-transitory computer readable medium of claim 15, wherein the operations further comprise:
determining whether the support request is in form of a ticket, a question or a query; and
in accordance with a determination that the support request is in form of a ticket:
classifying the ticket using a classifier model into a ticket group of a plurality of ticket groups including a bug group, a defect group and an enhancement group, and
auto-resolving the ticket based on a support model associated with the ticket group.

20. The non-transitory computer readable medium of claim 19, wherein the operations further comprise:
obtaining feedback data indicating a degree of satisfaction from users for resolutions of the support request and other support requests;
generating a training dataset based on the feedback data and historical conversations with the users; and
re-training the natural language model, the classifier model and the support model based on the training dataset.
